(19) United States
(12) Patent Application Publication
(10) Pub. No.: US 2015/0230428 A1
(43) Pub. Date: Aug. 20, 2015

(54) Apparatus for Spraying and Treatment of Livestock

(71) Applicant: Huey Fussell, JR., Ambrose, GA (US)

(72) Inventor: Huey Fussell, JR., Ambrose, GA (US)

(21) Appl. No.: 14/623,446

(22) Filed: Feb. 16, 2015

Related U.S. Application Data
(60) Provisional application No. 61/940,426, filed on Feb. 15, 2014.

(51) Int. Cl. A01K 13/00; B05B 15/12

(52) U.S. Cl. CPC A01K 13/001; B05B 15/12

(57) ABSTRACT

An apparatus for spraying and treatment of livestock has a frame with adjustable side sprayer nozzles, adjustable overhead spray nozzles, and bottom sprayer nozzles. Sensors attached to adjustable sensor bars determine actuation of the sprayer nozzles as animals enter a chute. A combination of side guide rails and spring rods keep animals centered while passing through the chute. A trailer tongue and wheels are attachable to the frame for transport of the apparatus as a trailer. Gates are hinged to the frame for use of the apparatus with an opening in a fenced area.

### PRIORITY CLAIM

The present application claims benefit of U.S. provisional application Ser. No. 61/940,426 filed on Feb. 15, 2014.

### BACKGROUND OF THE INVENTION

1. Field of the Invention

The present invention relates to treatment of animals and more particularly to an apparatus to keep the bodies of livestock clean to improve their health and for treatment or care to remove bugs and parasites.

2. Discussion of the Prior Art

Animal sprayers are popular as a means to clean livestock and treat livestock for parasites and, as a result, various models have been suggested for fixed and mobile animal sprayers. Several examples follow.

U.S. Pat. No. 2,524,641 to Green B. Suttles, Jr. teaches a portable animal spraying device with both a spray compartment and drip compartment.

U.S. Pat. No. 6,966,276 to D. Alton Dollar teaches a towable livestock sprayer with a wheeled subframe.

U.S. Pat. No. 5,063,880 to Rock J. Bouthillier teaches an automatic spraying device that detects animals for spraying and times the process for deactivating a pump.

U.S. Pat. No. 3,763,828 to Peter R. Tighe teaches a spray device with nozzle in a cow's passageway that the cow must step over to pass. The nozzle below the cow sprays upward to spray the cow's udder.

U.S. Pat. No. 4,379,440 to Thedford and Wilson teaches a livestock spray apparatus with a chute structure and rub panel to provide adjustable guidance for directing different sizes of animals through the chute. The apparatus includes a floor structure for solution filtration.

U.S. Pat. No. 4,987,861 to Lemire and Boyer teaches an apparatus for spraying animals that is mounted to an entranceway for animals. It consists of a U-shaped tubular structure.

Despite the variety of models suggested and patented, a need continues to exist for a portable animal sprayer with the advantage of being simple to manufacture while still providing a combination of the many advantages found in individual examples listed above.

### SUMMARY OF THE INVENTION

It is an object of the invention to improve the animal sprayer and overcome existing problems with missing features or complex and expensive design. Thus, the present invention is intended to provide a practical transportable trailer structure for a portable sprayer that is able to treat animals of all sizes efficiently.

Another object of the invention is to provide a transportable apparatus for spraying of livestock that can be used effectively for treatment of livestock for internal and external parasites, while also being efficient for cleaning of livestock and treatment for flying insects.

Another object of the invention is to provide a transportable spraying apparatus adjustable for any size animal without wasting chemicals.

Another object of the invention is to provide a spraying apparatus adaptable to any fence with a gate or opening.

These and other objects of the invention will be apparent to those skilled in the art based on the detailed description that follows below.

### BRIEF DESCRIPTION OF THE DRAWINGS

FIG. 1 is a perspective view of the apparatus for spraying and treatment of livestock constructed in accordance with a preferred embodiment of the invention.

FIG. 2 is a side view of the apparatus of FIG. 1 illustrating entry of a livestock animal into the apparatus.

FIG. 3 is a rear end view of the apparatus in accordance with an embodiment of the invention illustrating attachment of gate members to a frame of the apparatus.

FIG. 4A is an overhead top view of the apparatus illustrating entry of a livestock animal from the rearward end of the apparatus.

FIG. 4B is an overhead top view of the apparatus illustrating entry of a livestock animal from the forward end of the apparatus and demonstrating in contrast to FIG. 4A that the apparatus can be arranged for alternative entry from either end.

FIG. 5 is a schematic flow chart illustrating a preferred embodiment of the arrangement the sensors, motor, valves and sprayers.

### DETAILED DESCRIPTION OF THE INVENTION

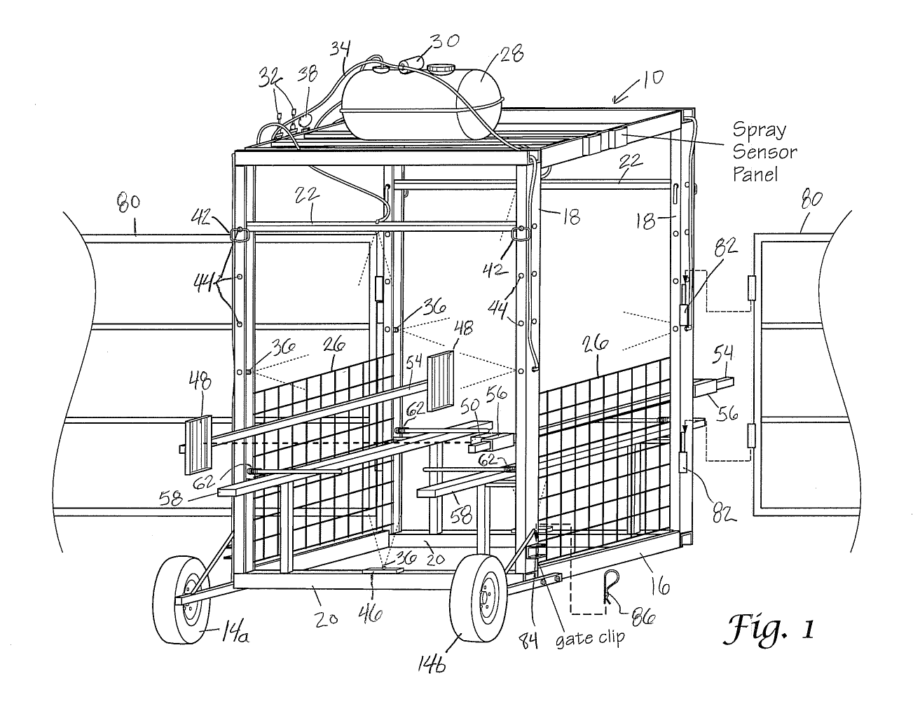

Referring now to the figures, FIG. 1 shows an apparatus for spraying and treatment of livestock comprising a transportable frame 10 forming a chute for receiving animals 12 for treatment while also being adapted for attachment of wheels 14a, 14b and a trailer tongue for transport as a trailer. The frame 10 forms an interior body of the apparatus with a chute opening for animals on each end. The interior body of the apparatus is about 48 inches wide, and 80 inches high. The structural members comprising the frame 10 may be constructed of channel metal members of various sizes.

The external frame members shown are primary constructed of 3-inch channel metal that forms both horizontal side frame members 16 on each opposing left and right side of the frame and vertical end frame members 18 on each opposing forward and rearward end of the frame 10. The internal lower cross members 20 shown are also constructed of 3-inch channel metal for sturdy support. Whereas, the internal upper cross members 22 are adjustable and function as overhead nozzle bars as discussed below and may be constructed of smaller and light 2-inch channel metal.

A foot 24 is attached to the forward end of frame 10 for resting the apparatus on the ground during the spraying function. The foot 24 provides about a 3-inch gap between the bottom of the frame and the ground to reduce rust and prolong the life of the apparatus.

The horizontal side frame members 16 and vertical frame members 18 define the perimeter of the sides of the frame 10. The vertical frame members and the lower cross members 20 and upper cross members 22 define the forward opening and rearward opening on the ends of the apparatus. The frame 10 further defines a chute for animals to enter and exit via the forward and rearward openings on each end. A fence lattice 26 may be attached to the sides of the frame to prevent animals from trying to escape the chute of the frame laterally or reach members of the animal such as the animal's head out of the chute laterally.

The apparatus is a mobile unit that is transportable as a trailer. In particular, the apparatus includes the wheels 14 attached to the rearward end of the frame 10 of the apparatus for transport and includes a trailer tongue with a 2-inch tongue coupler attached to the forward end of the frame of apparatus. The trailer tongue allows the apparatus to be hauled as a trailer by a pickup truck or vehicle. The trailer tongue can be unhooked from the frame by pulling a hitch pen.

A tank 28 is located on the top of the frame 10 and is coupled to a motor comprising a motorized 12-volt pump 30 for filling the tank quickly. A pressure relief valve 32 is attached to the tank 28 to adjust the proper amount of pressure coming from the tank of liquid chemicals for transfer through conduit hoses 34 to the sprayer nozzles 36. Adjusting the pressure of the fluid delivery controls and adjusts the amount of spray per unit of time sprayed so that a proper amount of chemical is applied to each animal during the spraying process. Adjustment provides for each animal to receive the required full treatment needed without waste so that the correct amount is applied to assure effective treatment for parasites and the like. Proper adjustment can prevent parasites becoming immune because of under treatment. In the particular embodiment, the operator turns the valve 32 clockwise to increase the pressure and, thereby, the spray level. The operator turns the valve counterclockwise to decrease pressure and the spray level provided by the fluid supply. If it is necessary to remove chemical from the tank 28, a release valve 38 on the fill up line that can be opened to release chemical from the tank.

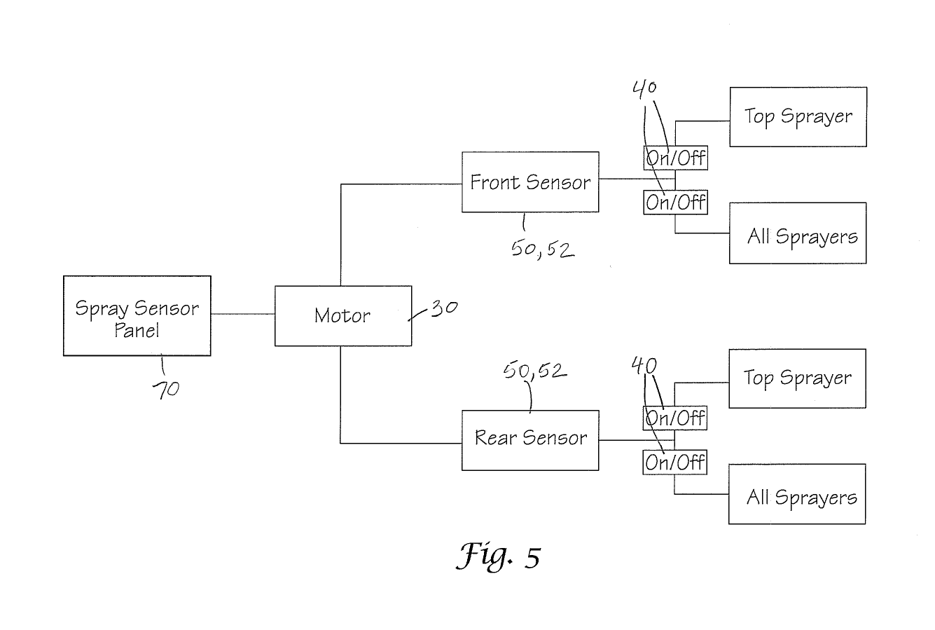

A first overhead nozzle configuration provides a nozzle 36 for spraying a straight stream used for treating internal parasites or worms by spraying a line down back of animal. A cut-off valve 40 is provided between the tank and the sprayer nozzles 36 to direct all spray to the over the top sprayer nozzles as illustrated by the schematic of FIG. 5. Using the cut-off valve all fluid can be routed to the top nozzles for treating animals for parasites. The valve is turned off to cut-off fluid to the side nozzles. The valve is turned on or opened to direct fluid to all of the nozzles for four-way directional spraying on the top, bottom and left and right sides of the animal. This is used for cleaning the animal as discussed herein. A second overhead nozzle configuration provides a nozzle for spraying a stream that is about the width of the animal for cleaning the animal or treating external parasites.

The over the top sprayer nozzles are attached to the internal upper cross members 22 that function as an overhead nozzle bar, also referred therefore as 22 herein. A first and second overhead nozzle bar are provided on each end of the frame 10 of the apparatus and attached between the vertical frame members 18 on each end. The height of the overhead nozzle bars 22 can be adjusted to various positions. In the depicted embodiment of FIGS. 1-3, six different height positions are provided using a combination of a lock pin 42 inserted through an aperture 44 through the vertical frame member 18 and the overhead nozzle bar 22. Proper height adjustment is vital to assure the correct spray pattern. Applying the correct spray pattern will cover the entire animal. If the height of the overhead nozzle bar is too high, the spray pattern will be too wide and will overlap the animal, causing waste of chemical and possibly over application. If the height of the overhead nozzle bar is too low, the spray pattern where it contacts the animal will be too narrow and will not apply chemical correctly to the entire animal, as some coverage may be lacking.

Side sprayer nozzles 36 are mounted and attached to the vertical frame members 18 on each end of the frame of the apparatus. These side sprayer nozzles spray chemical on the animal for cleaning and treatment for external parasites and flying insects. The side sprayer nozzles are attached to the vertical frame members using flexible hose, whereby the height of the side sprayer nozzles might be adjusted according to the size of animals typically treated by the apparatus. Several preset heights may be built into the vertical frame members by provide receptacle holes for receiving the respective side spray nozzle in the respective vertical frame member.

Protected bottom sprayer nozzles 36 are attached to bottom cross-members 20 of the frame 10 of the apparatus on each end. The bottom sprayer nozzles spray upward as the animal moves through the chute of the apparatus to clean or treat the bottom side of the animal 12. A mount 46 on the cross-member 20 in combination with the rigid cross-member protects the bottom sprayer nozzles. Each animal steps over the cross-member while passing through the chute and being sprayed.

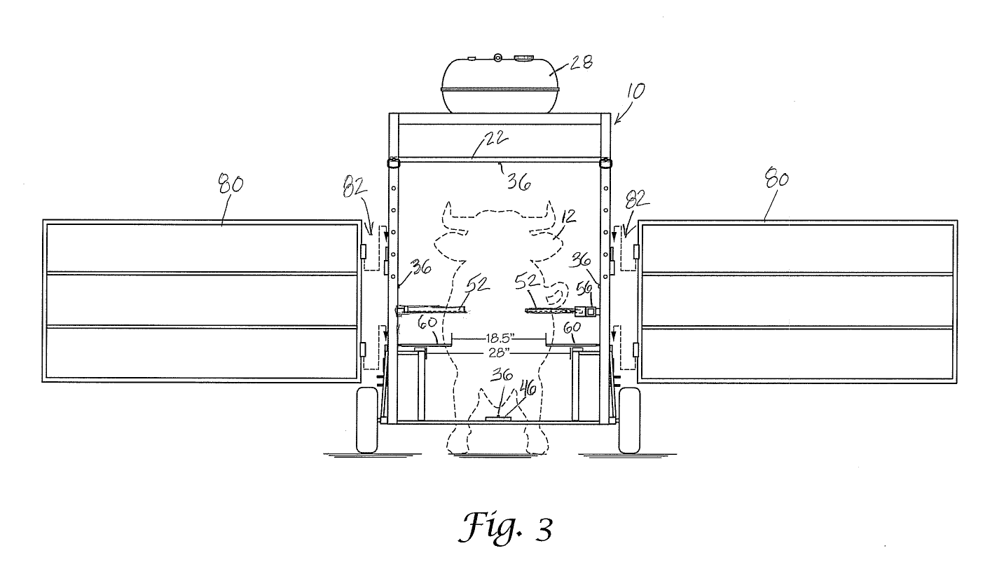

The apparatus may include adjustable optical sensors 48 and reflectors 50 on each side of the frame, or a mechanical arm 52 may be mounted as a sensor to be physically activated by the animal 12. In the embodiment with optical sensors, the sensors are attached to an elongate sensor bar 54 that can adjust to multiple positions. Alternatively, the mechanical arms are mounted on each end of the elongate sensor bar 54 and adjusted to the appropriate position for physical activation by the animals. The sensor bar 54 is attached to opposing vertical members 18 of the frame 10 of the apparatus to run lengthwise along the side of the frame. For a laser or light based sensor, a separate sensor bar is located on each side of the frame holding sensors 48 on a first sensor bar on one side and holding reflectors 50 for receiving light on a second sensor bar on the opposing side. For a physical mechanical arm sensor 52, a single sensor bar 54 or opposing bars on opposite sides of the frame as shown in FIG. 3 may be installed depending on the application and dependability desired by the consumer.

The operator can adjust the sensor weight to start the spraying process when animal 12 from 0 to up to 24 inches past the first sprayer nozzle 36 so as not to scare the animal or to ensure proper placement to treat the needed portion of the animal's body, especially according to the animal's size. Loosening a holding device such as a screw and sliding the sensor 50, 52 outward or inward from the end of the supporting sensor bar 54 can adjust the sensor weight. In the structure shown, the sensor 50, 52 is attached to a metal bracket 56 that slides via the length of sensor bar 54 to adjust the location of the sensor on the sensor bar. The location of the sensor on the sensor bar delays the signal to the sprayer control by the sensor to send pressurized fluid to the sprayer nozzles until the animal has entered further into the chute the desired distance.

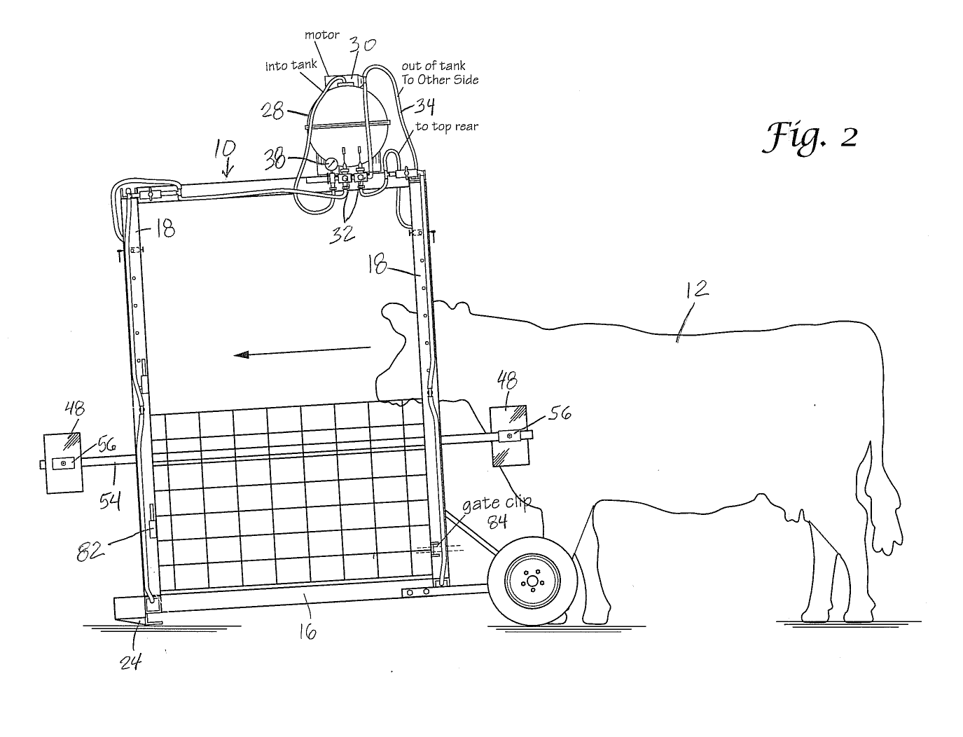

Once the sensor 50, 52 determines that the animal 12 has entered the apparatus to the desired distance, then a signal is sent by sensor because the animal moves the mechanical sensor 52 as in FIG. 3 or blocks the transfer of light from the optical sensor 50 to a reflector 48 using the type of sensor shown in the embodiment of FIGS. 1-2. The signal causes spray to begin distributing treatment fluid to animal. The closer the sensors are to the nozzles 36, the more of the body of the animal gets sprayed. Likewise, the farther away from the sprayer nozzles the sensors are, the less the body of the animal is sprayed. In particular, with the pour-on type wormer chemical, specifications for the chemical recommend applying the chemical along the shoulders of the animal and along the animal's back toward the rear. Whereas, a band spray fluid needs to begin spraying immediately behind the animal's ears. By adjusting the sensors, the spray can begin either at the shoulders or behind the ears according to the preferred location on the animal.

Operators can adjust the height of the sensors 50, 52 for the general stature of the animals. The proper height selected by removing two bolts on each side holding the sensor bar 54 and then reattaching the bolts to fix the height. The operator can both raise and lower the sensors to the desired proper height. In the embodiment shown, the sensors can be adjusted to three different height positions. Other methods can provide additional adjustment mechanisms whereby variable positions may be provided. Adjustment of the height of the sensors will help to promote proper application on large cows or horses, or adjustment may promote application to smaller animals such as young calves, goats, and sheep. Setting the sensors at a higher height may prevent the sprayer from activating when smaller animals cross through the apparatus. Thereby, small animals will not be over treated with chemical when the intent is to treat larger animals.

By switching the sensors 50, 52 from one end to the other of the sensor bar 54 the apparatus can be modified for spraying as an animal 12 enters from left to right or alternatively from right to left. Further, the sensors can be arranged on both ends of the apparatus so that the spray can be actuated by entry of an animal from either end. In other words, the animal could enter from either left to right or right to left and receive spray treatment.

The apparatus includes side guide rails 58 attached to the frame 10 of the apparatus. In the embodiment of FIG. 1, the side guide rails 58 are fixed to the bottom cross-members 20 of the frame at the desired width and distance from the sides of the frame or apparatus, which is 28.5 inches wide in embodiment shown. The side guide rails keep the animals underneath the sprayer nozzle by placing the animal in line with the spray nozzles, especially those above. The alignment of the animal ensures that a uniform spray pattern will be applied to all four sides of the animal. The rails extend about two feet past the spray nozzles on each end of the chute of the apparatus to allow room and timing for the animal to be in line with the spray nozzles. By the rails extending past the sprayer nozzles 36, the apparatus promotes keeping the animals walking and moving through the chute in a straight line even while the sprayers are disturbing the animals by spraying chemical on them.

Spring rods 60 are attached to each side of chute onto side guide rails 58 or vertical frame members 18 and designed to guide the animal 12 into the center of the chute. As discussed, the animal being centered in the chute helps ensure an even spray pattern. By using spring rods 60 rather than adjusting the side guide rails 58 into a narrower configuration, the apparatus is able to accommodate a larger variety of animals in a single configuration of the guide rails, while still keeping the animals centered. The opening between the two spring rods 60 guides the animal into the center of the opening, as the animal perceives that path as having the least resistance by the opening and the spring-loaded pressure of the rods. Smaller animals stay centered between the openings of the spring rods.

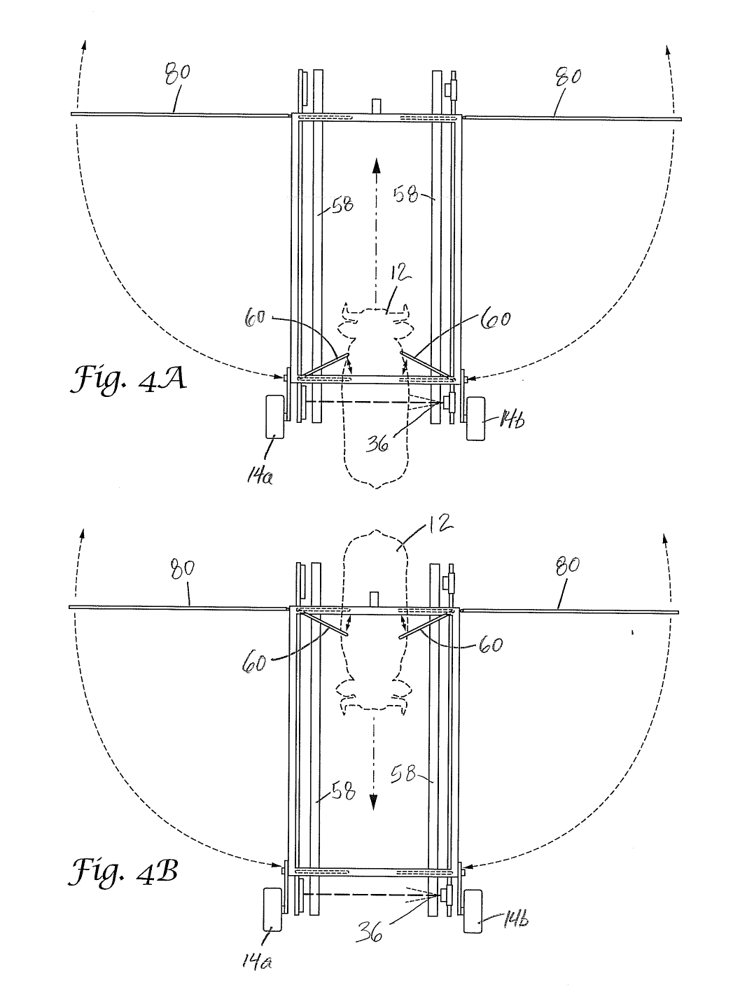

The spring rods 60 are spring loaded to a biased position perpendicular to side guide rails 58. The spring rods 60 move inward via the spring 62 attaching each of the spring rods to the frame or guide rail as the animal 12 moves through chute. The spring rods function to narrow the chute to center the animal within chute. As the spring rods are pushed out of the way by larger animals as shown in FIGS. 4A and 4B, they then return to the correct position after the animal has walked through. In the embodiment shown, the rods move outward when moved by the animal from about 14 to 20 inches to 28 inches. The spring rods can be modified to adjust the dimensions of chute desirable in the practice of the invention. The combination of the spring rods 60 with the side guide rails 58 ensures that the animal travels through the center of the apparatus so that the spray nozzles 36 spray uniformly from the sides and spray the center of the animal from above and below.

A panel box attached on the frame 10 of the apparatus and includes a spray sensor panel 70 that has a one second timer or a three second timer switch. For example, to spray for internal parasites, a user will use the one-second switch. Whereas, to spray for worms where the animal is to be sprayed from the along the shoulders and onto the back, the one second switch may be used or adjusted as required. The three-second switch is particularly useful for spraying an animal to treat for external parasites such as flies and ticks, where the user sets the apparatus to spray the animal from behind the ears through the whole body. The panel box includes a primer switch to prepare the chemical and the spray nozzles for application prior to animals entering the chute of the apparatus.

A hinged gate 80 is attached to the vertical side members on the forward end of the frame. Hinges 82 are attached to the vertical side members 18 on opposing sides of the forward opening of the apparatus to hold separate gates 80 that extend from each side of the apparatus. The gates may be used to contain animals for entry into the chute of the apparatus. In particular, the apparatus may be positioned such that each gate abuts a fence on either side of an opening in an animal containment area. Each gate member is hinged so that the gate members may be folded against the sides of the apparatus for travel. Once folded, the gates can be retained in parallel relation to the sides using a gate clip such as a cotter pin 86 inserted through a bracket 84 attached to the side of the frame and a tab extending from an end of the gate opposite from the hinged end.

I claim:

1. An apparatus for spraying and treatment of livestock comprising:
a. a frame including vertical side members and horizontal side members defining opposing left and right sides of the frame and said vertical side members and internal upper cross members and internal lower cross members defining opposing front and rear ends of the frame, and said opposing sides and ends defining a chute for receiving livestock;
b. said internal upper cross members are adjustable and provide overhead nozzle bars and the overhead nozzle bars are adjustable to various height positions;
c. top sprayer nozzles are attached to the overhead nozzle bars;
d. side sprayer nozzles are mounted and attached to the vertical frame members and the side sprayer nozzles are adjustable to several preset height positions;
e. bottom sprayer nozzles are attached to the internal lower cross members and arranged to spray upward; and
f. a sensor is attached to the apparatus, whereby a selection of the top, side or bottom sprayer nozzles are activated by the sensor during entry of a livestock animal into the chute for the spraying and treatment of the livestock.
